(19) United States
(12) Patent Application Publication
(10) Pub. No.: US 2002/0186906 A1
(43) Pub. Date: Dec. 12, 2002

(54) Impregnated bearing for air fans

(76) Inventor: Bill Lee, Chu-Pei City (TW)

Correspondence Address: BACON & THOMAS, PLLC, 625 SLATERS LANE, FOURTH FLOOR, ALEXANDRIA, VA, 22314

(21) Appl. No.: 09/876,096

(22) Filed: Jun. 8, 2001

(51) Int. Cl. F16C 33/02

(52) U.S. Cl. 384/276

(57) ABSTRACT

An improved impregnated bearing for air fans comprises a bearing which has a spindle aperture running through two ends thereof. The spindle aperture has an expanded bore of a greater diameter than the spindle aperture formed at a selected location thereof, and the spindle aperture has a front aperture and a rear aperture which have an equal diameter, whereby to increase matching precision of the bearing, reduce friction area, greatly decrease heat generation and increase durability of the bearing.

### BACKGROUND OF THE INVENTION

This invention relates to an improved impregnated bearing for air fans and particularly an impregnated bearing that has an expanded bore located in the middle section of the bearing for enhancing bearing matching precision and reducing the friction area to decrease heat generation and increase bearing durability.

Air fan motor is a commonly used cooling and heat dissipating structure mainly being used in electronic devices or electrical machinery (such as computer processors, video cassette recorders, copiers, and the like) for discharging heat energy generated during the operation of the electronic devices and electrical machinery to meet the cooling requirements thereby to protect the components of the electronic devices or electrical machinery from damaging by high temperature and to extend their durability.

A conventional air fan (as shown in FIG. 1) generally consists of a body and a blade seat. The blade seat has a hollow frame with the blades mounted at the periphery thereof. The inner circumference of the hollow frame has magnets disposed thereon and a positioning spindle located in a protrusive manner at the center. The body has a positioning seat formed at the center thereof. The positioning seat has a protrusive strut at the center which has a through opening formed therein. The through opening has an extended supporting surface for holding a bearing which has a spindle aperture formed in the center thereof. Around the periphery of the protrusive strut, there are provided with circuit boards and coils.

The positioning spindle is disposed directly in the spindle aperture. The positioning spindle has two circular oil rings located at two ends of the bearing. The magnets of the blade seat are located at the outer rim of the coils. When the circuit boards and coils receive electricity and energized, the blade seat is turned through the bearing about the positioning spindle thereby to rotate the blades. When the positioning spindle rotates relatively against the bearing, bearing will release lubricating oil from the sintered cavities for lubricating the bearing and positioning spindle.

When the bearing automatically releases the lubricating oil (as shown in FIG. 2), the lubricating oil will spray around from the oil ring resulting from the centrifugal force, and flows out from the gaps (shown by the arrow mark direction). As a result, lubrication oil will be consumed gradually. Other factors such as pressure, increasing temperature, oil spraying or the like will also cause the oil content in the bearing decreasing gradually. Once the lubricating oil in the bearing is exhausted, the positioning spindle and bearing will have excess friction due to no lubricating oil and will result in damage of the positioning spindle or bearing. Consequently the air fan will not function properly and will generate noise or cause the positioning spindle stuck, and decrease the bearing durability.

Moreover, the spindle aperture is formed by machining a uniform diameter in the bearing body and will result in the disadvantages mentioned above during operation. As the spindle aperture is relatively lengthy and will cause downgrade of straightness of the axis line, consequently precision degree of the straightness of the bearing aperture contour, circularity, and circular jump and parallel degree will also suffer. Hence when to match the bearing and positioning spindle, it is difficult to maintain the high precision required. Furthermore, when the spindle aperture is lengthy, the contact area between the spindle aperture and positioning spindle increase, and will generate a great amount of heat. The consumption of lubricating oil will also increase due to the large contact area and will result in lower durability of the bearing.

### SUMMARY OF THE INVENTION

The primary object of this invention is to resolve aforesaid disadvantages. The improved impregnated bearing for air fans of this invention has an expanded bore formed at the middle section of the impregnated bearing. Such a structure can significantly increase the matching precision of the bearing, reduce the friction area and greatly decrease heat generation and increase bearing durability.

In order to attain aforesaid objects, the bearing according to this invention has a spindle aperture run through two ends of the bearing. At a selected location of the spindle aperture, an expanded bore is formed which has a greater diameter than the spindle aperture. The spindle aperture has a front aperture and a rear aperture which have an equal diameter. By means of such a structure, matching precision of the bearing can be increased significantly, friction area also may be reduced, heat generation will be greatly decreased, as a result, bearing durability can be increased.

The foregoing, as well as additional objects, features and advantages of the present invention will be more readily apparent from the following detailed description, which proceeds with reference to the accompanying drawings.

### BRIEF DESCRIPTION OF THE DRAWINGS

FIG. 1 is a sectional view of a conventional air fan motor.

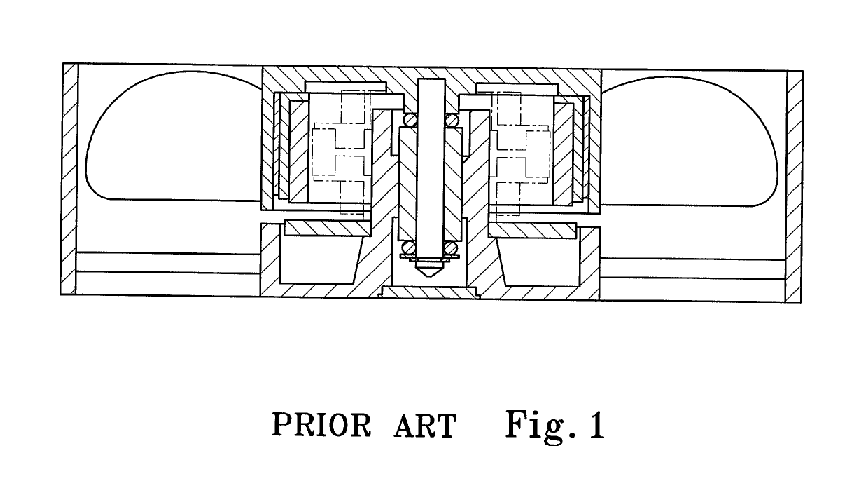

FIG. 2 is a fragmentary enlarged view of FIG. 1.

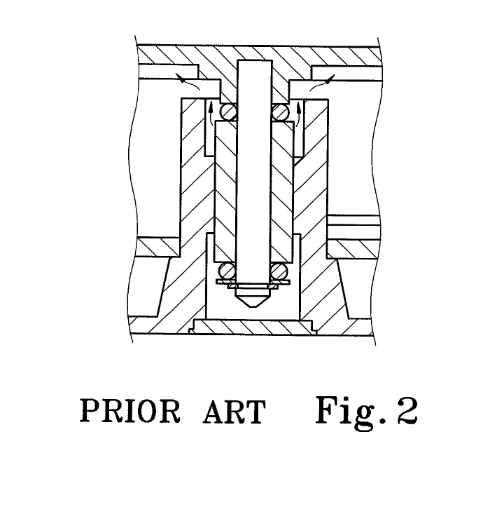

FIG. 3 is a perspective view, partly cut away, of this invention.

FIG. 4 is a sectional view of this invention.

FIG. 5 is a sectional view of this invention in use.

### DETAILED DESCRIPTION OF THE PREFERRED EMBODIMENT

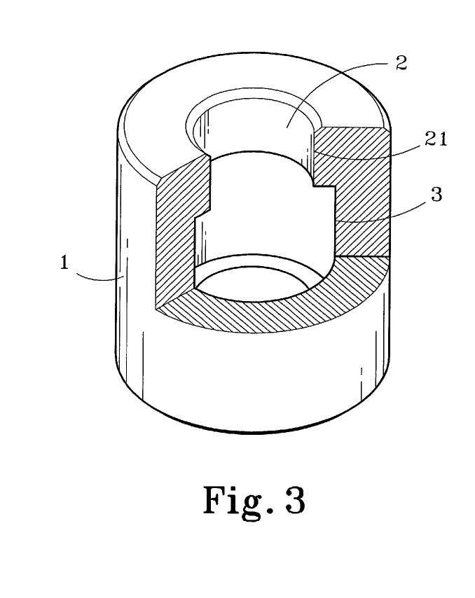

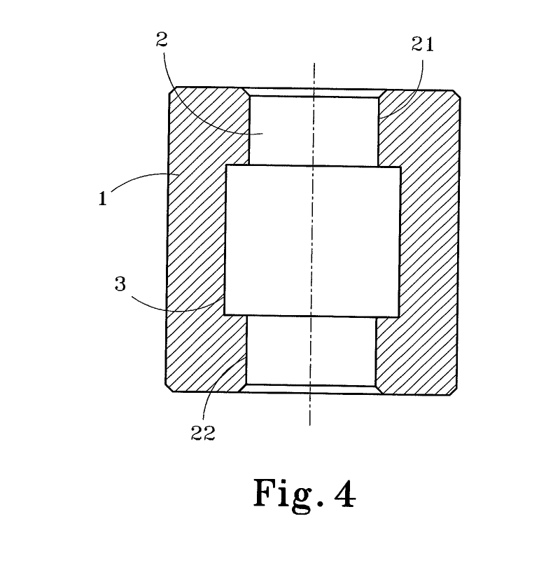

Referring to FIGS. 3 and 4, the improved impregnated bearing according to this invention consists of a bearing 1 which has a spindle aperture 2 running through two ends thereof and an expanded bore 3 formed at a selected location in the spindle aperture 2. The expanded bore 3 has a diameter greater than the spindle aperture 2. The spindle aperture 2 includes a front aperture 21 and a rear aperture 22 which have an equal diameter. The axes of the apertures 21, 22 and expanded bore 3 are located at the same straight line. By means of such a structure, the matching precision of the bearing 1 can be increased significantly, friction area can be reduced, heat generation can be greatly decreased, and the durability of the bearing 1 can be increased.

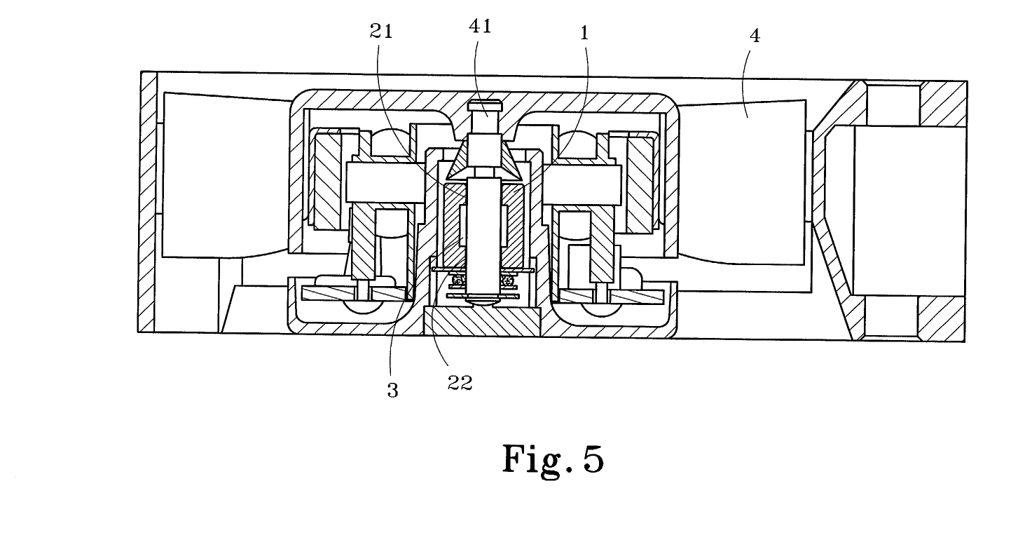

Referring to FIGS. 4 and 5, when this invention is in use, dispose lubricating oil in the expanded bore 3 of the bearing 1, place the positioning spindle 41 of an air fan blade 4 through the spindle aperture 2 with the axes of the front aperture 21, rear aperture 22 and expanded bore 3 aligned at the same straight line. Hence when the positioning spindle 41 runs through the spindle aperture 2, the expanded bore 3 surrounds the positioning spindle 41 at a desired location. When the air fan blade 4 rotates, because of the expanded bore 3 surrounding the positioning spindle 41 at the desired location, the contact area between the spindle aperture 2 and positioning bore 41 becomes smaller, hence the matching precision between the spindle aperture 2 and the air fan blade 4, and the precision during operation will be increased significantly. Furthermore, due to the contact area between the spindle aperture 2 and positioning spindle 41 has been greatly reduced, heat generation resulting from friction between the bearing 1 and positioning spindle 41 will also decrease greatly. The smaller contact area between the spindle aperture 2 and positioning spindle 41 may further reduce the oil consumption speed contained in the expanded bore 3. As a result, the bearing 1 will have a longer durability.

In summary, the improved impregnated bearing of this invention can effectively resolve the shortcomings of the conventional air fan bearing, and results in better, more stable and more practical usage.

What is claimed is:

1. An improved impregnated bearing for air fan comprising a bearing which has a spindle aperture running through two ends thereof, the spindle aperture having an expanded bore of a greater diameter than the spindle aperture formed at a selected location of the spindle aperture thereby to increase matching precision of the bearing, reduce friction area, greatly decrease heat generation and increase durability of the bearing.

2. The improved impregnated bearing of claim 1, wherein the spindle aperture includes a front aperture and a rear aperture, the axes of the front aperture, the rear aperture and the expanded bore being located at a same straight line.

3. The improved impregnated bearing of claim 2, wherein the front aperture and the rear aperture have an equal diameter.
